(19) United States
(12) Patent Application Publication
(10) Pub. No.: US 2006/0085516 A1
(43) Pub. Date: Apr. 20, 2006

(54) Method and apparatus for providing a work flow web application that receives image data via a web browser and exports the image data to a document processing server

(76) Inventors: Bradford Heeth Farr, Lexington, KY (US); Jae Young Kim, Lexington, KY (US); Wai Ping Shiu, Lexington, KY (US); Norman Erik Stang, Lexington, KY (US); William Thomas Warner III, Lexington, KY (US); Timothy Gerard Yorkey, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 10/957,017

(22) Filed: Oct. 1, 2004

(51) Int. Cl. G06F 15/16

(52) U.S. Cl. 709/217; 709/246

(57) ABSTRACT

An improved image processing system is provided which receives image data at a computer and transfers that image data to a work flow server for image processing and document distribution. The system uses a work flow web application computer program that receives image data from a scanner, transfers that image data via a native interface or a driver on a client computer to a browser on the client computer, and then sends the data to a network document distribution server which is addressed from the client computer using URL's.

### TECHNICAL FIELD

The present invention relates generally to image and document processing equipment and is particularly directed to a system of the type that receives image data at a computer and transfers that image data to a work flow server (WFS) for image processing and document distribution. The invention is specifically disclosed as a work flow web application (WFWA) that receives image data from a scanner, transfers that image data via a native interface or a driver on a client computer to a browser on the client computer, and then sends the data to a network document distribution server, which is addressed using URL's.

### BACKGROUND OF THE INVENTION

In conventional systems, there are many optical image scanners, AIO (All-In-One) devices, and other types of imaging devices that are connected to client personal computers (PCs) via local connections such as USB ports, parallel ports, serial ports, etc., or via network connections such as IP ports or LAN ports. Such devices typically use a TWAIN driver to act as the interface between the PC and the image device. Some of these systems provide a network connection between the scanner and the PC and allow users to command the scanner to acquire the image from a remote location, using a virtual TWAIN driver. Other systems acquire the image data on a PC or workstation from the image-sourcing device, and then send the image data over a network to a remote printer. Some of the conventional systems have been patented, as discussed immediately below:

U.S. Pat. No. 6,429,952 discloses a first embodiment having a PC connected to an HTTP server, which is connected to a scanner. The PC has a browser, and scanning parameters are set from the browser and the scanner's operation is controlled by the browser. The data to the PC can be sent as HTML pages or Java applets. These applets could validate the scanning parameters. The user at the PC (or terminal) enters an Internet Protocol (IP) address or a Uniform Resource Locator (URL) of the scanner into the web browser. In a second embodiment, the scanner is connected to a PC. The PC still has a resident browser, and the scanning parameters are still set by the browser. The inventor of the '952 Patent states that conventional scanners have been requiring special purpose protocols, such as TWAIN, to transfer data and to handle control, and instead he proposes to allow a user to directly import a scanned object into the browser. One purpose of the '952 patent is to centralize the user interface within the scanning device so that utilizing a standard browser interface, unique features can be exploited without modifying any host drivers and also so as to utilize a standard browser interface. In this manner, the scanner may be used on any host platform without special drivers, which (otherwise) are usually required to be located on the terminal that is using the scanned data. The “server” function is incorporated into the firmware of the scanner (i.e., there is no separate server hardware device), thus integrating the scanner's control software, the server's control software, and any “device-specific driver” software into the scanner device itself. This allows the browser (on the user's PC) to talk directly to the scanner device's firmware, thereby allowing the browser to directly set the scanning parameters. This of course would require special software to be loaded onto the scanner.

U.S. Pat. No. 5,911,044 discloses an image scanning system that can transmit image data from a remote scanner, over a network, to a client PC. The image scanner is connected to a scanner server that has a TWAIN driver to talk to the scanner. The PC has a virtual TWAIN driver that allows an application program on the PC to act as if the PC is directly connected to the remote scanner. The user reads the scanning parameters and can then set these to other values, before the scanning operation occurs.

U.S. Pat. No. 6,003,093 discloses workstations connected to a network, and to image scanners, either directly or over the network. The workstation can have multiple TWAIN stub data sources, each for an image input device (e.g., a scanner or a fax machine). The TWAIN stub sources can be called by another image processing application requiring device driver functionality. A TWAIN protocol manager receives commands as TWAIN triplets. A TWAIN source manager locates a valid stub data source; the image manager then tells the device manager to load the correct device driver, which controls a scanning operation. The image data can be sent from a stub source to another imaging application. A local scanner connected to a particular PC on the network can receive image data, and then send the image data to a remote printer via a network server.

U.S. Pat. No. 6,301,586 discloses a system that maps multimedia objects such as text, images, sound, and video clips. User-activateable selections of a field from a multimedia database can accompany a printout of the multimedia objects. The user can obtain a thumbnail view of images in the multimedia objects. It can access TWAIN compatible devices. A view manager manages different view presentation ActiveXs. It includes an internal web browser which has simplified functionality (Back, Forward, Refresh, Stop, and so on).

Lexmark International, Inc. sells a document handling, processing, and distribution system called the “Lexmark Document Solutions Suite” (LDSS), which has many capabilities for communicating with printers and personal computers (PCs) over a network, such as a company Local Area Network (LAN). There are several PC (Windows-type) applications, such as “Select 'N Send” and “Print 'N Send,” that operate with the LDSS system which can feed files and print jobs into the LDSS system from client/user PCs. The LDSS system also works with Lexmark MFP (Multi-Function Printer) devices to control and manage the op-panel of the MFPs and the user interface on the MFP hardware. In addition, images scanned off of the MFPs can be fed into the LDSS system. In one configuration, the LDSS package resides on a server, and its software functions are then made available to multiple users on the network.

As noted above, there are many scanners, AIO (All-In-One) devices, and other imaging devices that are connected to client PCs via local connections such as USB ports, parallel ports, serial ports, etc., or via network connections such as IP ports or LAN ports. However, at this time, there are no applications that can acquire images from these devices through client PCs, and then feed the image data into a work flow server. It would also be an improvement to communicate image data to a document distribution server by use of a web browser interface.

### SUMMARY OF THE INVENTION

Accordingly, it is an advantage of the present invention to acquire image data from an image source and upload that image data to a client computer, then use a web browser to further upload the image data to a network document distribution server, under the control of a work flow web application computer program.

It is another advantage of the present invention to provide a client computer with a work flow web application computer program, a standard web browser, an image-acquiring device driver, and a software interface module that allows the image driver to communicate with the browser, and after acquiring an image, to transfer the image data to a network document distribution server using one or more URL addresses.

It is yet another advantage of the present invention to acquire image data from an image source and upload that image data to a client computer, then use a web browser to further upload the image data to a network document distribution server, under the control of a work flow web application computer program that is configurable by a network administrator to allow multiple users to have different views of the work flow web application computer program at different client computers.

It is still another advantage of the present invention to acquire image data from an image source and upload that image data to a client computer, then use a web browser to further upload the image data to a network document distribution or work flow server under the control of a work flow web application computer program that allows the user to preview the scanned image data at one point in the process flow, later allows the user to have image processing performed by the network document distribution server, and at a further point in the process flow, allows the user to preview the processed image data.

It is a further advantage of the present invention to provide a client computer with a work flow web application computer program, a standard web browser, and a network document distribution server over a computer network, match up a list of available image drivers on the client computer to a list of supported devices by the network document distribution server, and then use an available image-acquiring device driver and a software interface module that allows the image driver to communicate with the browser to acquire an image from a supported image sourcing device and transfer the image data using one or more URL addresses to the network document distribution server.

To achieve the foregoing and other advantages, and in accordance with one aspect of the present invention, a networked system is provided, which comprises: (a) a work flow server that is in communication with a computer network, the work flow server having a first processing circuit and a first memory circuit and containing first computer executable code; (b) a client computer that is in communication with the work flow server over the computer network, the client computer having a second processing circuit and a second memory circuit and containing second computer executable code; and (c) an image sourcing device that is in communication with the client computer, wherein the second computer executable code includes: (i) a web browser that is in communication with the work flow server over the computer network; (ii) an image device driver that is in communication with the image sourcing device; and (iii) a software interface module that interfaces between the web browser and the image device driver.

In accordance with another aspect of the present invention a method for receiving image data and processing image data using a work flow server that is in communication with a client computer over a computer network and an image sourcing device in communication with the client computer is provided, in which the method comprises the following steps: (a) establishing a communications session between the work flow server and the client computer over the computer network, through a URL in a web browser resident on the client computer, wherein the URL identifies an address on the work flow server; and (b) communicating first image data from an image device driver to the web browser resident on the client computer through a software interface module resident on the client computer.

In accordance with yet another aspect of the present invention, a method for receiving image data is provided, in which the method comprises the following steps: (a) providing a client computer and an image sourcing device that is in communication with the client computer; (b) generating a first image data at the image sourcing device and, under control of a work flow web application computer program, communicating the first image data to an image device driver resident on the client computer; (c) communicating the first image data from the image device driver to a software interface module resident on the client computer, under control of the work flow web application computer program; and (d) communicating the first image data from the software interface module to a web browser resident on the client computer, under control of the work flow web application computer program.

Still other advantages of the present invention will become apparent to those skilled in this art from the following description and drawings wherein there is described and shown a preferred embodiment of this invention in one of the best modes contemplated for carrying out the invention. As will be realized, the invention is capable of other different embodiments, and its several details are capable of modification in various, obvious aspects all without departing from the invention. Accordingly, the drawings and descriptions will be regarded as illustrative in nature and not as restrictive.

### BRIEF DESCRIPTION OF THE DRAWINGS

The accompanying drawings incorporated in and forming a part of the specification illustrate several aspects of the present invention and together with the description and claims serve to explain the principles of the invention. In the drawings:

FIG. 1 is a hardware block diagram showing some of the components used in the present invention, including a client PC and other components that are attached to a network, including a document distribution server, a printer, an image scanner, and other image forming or image sourcing devices.

FIG. 2 is a diagrammatic view illustrating some of the software functions utilized in one mode of the present invention, including those found on a document distribution server and a client PC, as according to the principles of the present invention.

FIG. 3 is a diagrammatic view illustrating some of the software functions utilized in a second mode of the present invention, including those found on a document distribution server and a client PC, as according to the principles of the present invention.

FIGS. 4, 5, and 6 are flow charts depicting some of the logical steps utilized in the present invention.

### DETAILED DESCRIPTION OF THE PREFERRED EMBODIMENT

Reference will now be made in detail to the present preferred embodiment of the invention, an example of which is illustrated in the accompanying drawings, wherein like numerals indicate the same elements throughout the views.

The present invention includes a work flow web application software program that can run on client PCs, and can interface with image devices connected to such client PCs. (It should be noted that the term “client PCs” may refer to personal computers, personal digital assistants, terminals, cellular phones, workstations or any other device that is operated by a human user. A “client PC” is also referred to herein as a “client computer.” The terms “software” or “software program” generally refer to a computer program that executes on a computing device, such as a microprocessor or a microcomputer. It should be noted that such computer software either can be in the form of executable code (sometimes called “object code”) that can be immediately executed by a computing device, or it can be in the form of interpreted code that must be first presented to an interpreter that, in real time, converts the interpreted code into a form of executable code that will be executable on a computing device.)

One form of the work flow web application program of the present invention has been released by Lexmark International, Inc. under the product name, “Lexmark Document Solutions Desktop,” which will often be referred to herein as the “LDSD” software package, the “work flow web application,” or perhaps merely “LDSD” or the “LDSD system.” The LDSD software described above executes on a client PC, however, it also has a component that executes on a work flow server. In the LDSD system, the typical work flow server device also includes another Lexmark software package marketed under the product name, “Lexmark Document Solutions Suite,” or “LDSS,” as noted above in the Background of the Invention. The LDSS server product has many capabilities, and only a few of those capabilities or functions are discussed in any kind of detail herein. However, many of these capabilities are described in Lexmark's product literature, and also are described in certain patent applications commonly assigned to Lexmark, as follows, which are incorporated herein by reference in their entirety: Ser. No. 09/783,368, titled “SERVER SYSTEM FOR AUTOMATIC MULTIPLE ACTION DOCUMENT PROCESSING,” filed on Feb. 14, 2001; Ser. No. 10/230,828, titled “SYSTEMS AND METHODS FOR USE OF PROFILES IN MULTI FUNCTION DEVICES,” filed on Aug. 29, 2002; and Ser. No. 10/424,591, titled “MULTI-FUNCTION DEVICE HAVING GRAPHICAL USER INTERFACE INCORPORATING CUSTOMIZEABLE ICONS,” filed on Feb. 28, 2003.

The work flow server and the work flow web application software of the present invention work hand-in-hand, as described herein. One feature of the present invention is the capability to access the work flow server by use of URL addresses, which involves the web browser aspects of the present invention. By use of this feature, the user at the client PC can initiate communications with the work flow server merely by opening his or her web browser program, and then entering the appropriate URL into the box or area typically used for bringing up an Internet website.

Another feature of the present invention is that the work flow web application on the client PC acquires image data from various client image devices through software interface modules, such as native interfaces (i.e., browser code that can access resources in the client PC) and then can feed the image data to the work flow server. The work flow web application has other features, such as allowing a user to select files on the client PC to be fed to the work flow server, similar to the “Select 'N Send” application; getting client/user input with dynamic prompting; previewing image data before image processing at the work flow server; and giving system administrators the ability to create more than one work flow web application view and to control the user interface for each of those views, and the like.

Hardware Description:

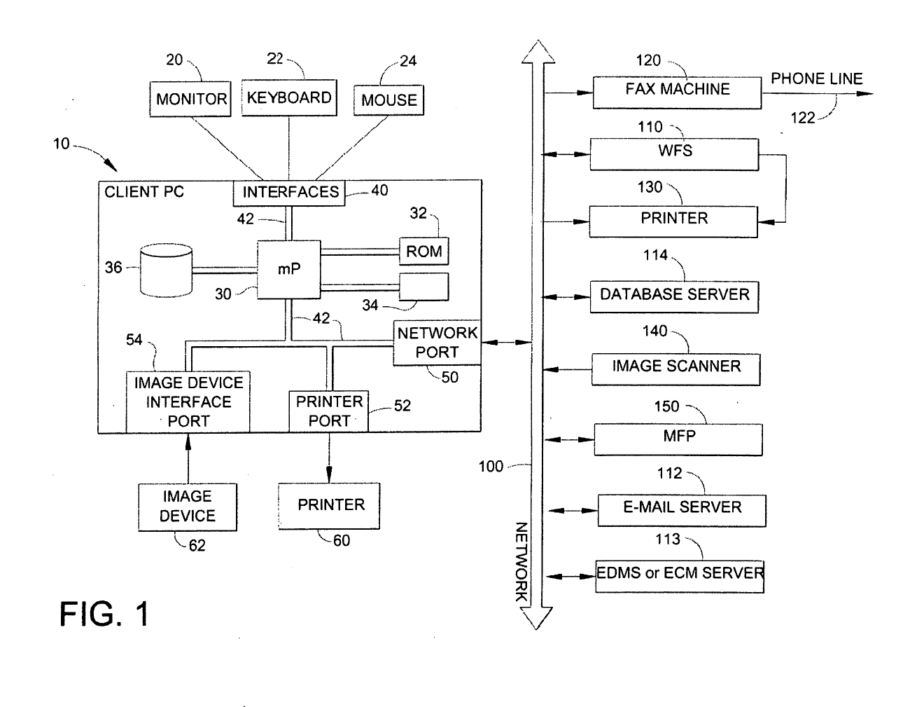

Referring now to FIG. 1, a hardware block diagram is illustrated, showing a host computer, generally designated by the reference numeral 10, which is also referred to herein as the “client PC.” This client PC 10 is the user's computer or workstation and typically has an associated monitor or display 20, keyboard (or other data entry device) 22, and mouse 24 (or other type of pointing device), which all talk to their appropriate interfaces at the reference numeral 40 on FIG. 1. The client PC 10 may also be any other device capable of running a browser. The heart of the client PC 10 would typically be a microprocessor 30, which can communicate to various types of memory devices, such as read only memory (ROM) 32, random access memory (RAM) 34, and a bulk memory device 36, such as a hard disk drive or perhaps an optical memory storage medium.

In a typical PC, the microprocessor 30 will communicate over various busses, generally designated by the reference numeral 42, to the other hardware components within the computer. In FIG. 1, some of the interface devices that communicate with the microprocessor 30 are a network port 50, a printer port 52, and an image device interface port 54. These external ports are described above in terms of their functionality, whereas in reality there are many types of network ports (such as Ethernet), there are many types of printer ports (such as parallel ports or USB ports), and there are various types of image device interface ports, including USB ports, for example.

The printer port 52 is designed for communicating with a local printer 60, while the image device interface port 54 is designed for communicating with a locally-attached image device 62, such as an optical scanner. Of course, other types of image devices can be used to acquire images at the client PC 10, including digital cameras. (It should be noted that the concept of an “image device” generally refers to an apparatus that is capable of generating a still image, usually comprising monochrome or color binary data in two dimensions. As noted above, it can consist of commonly-known devices such as digital cameras, image scanners, or even bar code scanners. Image devices are also sometimes referred to herein as “image sourcing devices.”)

The network port 50 is designed to be in communication with a network, generally designated by the reference numeral 100. Network 100 could be any network type that is compatible with the client PC 10, including a Local Area Network (LAN), a Wide Area Network (WAN), or an intranet, which are generally privately-connected networks. Network 100 could also be the Internet or a satellite or cellular network, if desired.

Many other hardware devices are designed for being in communication with the client PC 10 over the network 100. This includes an LDSS or work flow server 110, a fax machine 120, a printer 130, an image scanner 140, and a multifunction device (MFD) 150. MFD 150 is a printer device capable of performing multiple functions, such as printing, scanning, copying and faxing functions. Fax machine 120 can be in communication with and receive data directly from the network 100, either from the work flow server 110, after image processing for example, as discussed below, or from the client PC 10, if desired. On the output side, fax machine 120 can be connected to a telephone line 122, which could be a typical “slow” phone line, or may be some faster communication service.

Printer 130 may be in direct connection and receive data from the network 100, and it may also be directly connected to and receive data from the work flow server 110. The output of the printer is, of course, hard copy printouts. It will be understood that the more modern printers also can communicate in both directions to a host computer or a host server.

The work flow server 110 has the capability of sending e-mails via an e-mail server 112, storing data in or using a database server 114, and interfacing to an electronic document management system (EDMS) or an electronic content management system (ECM) server 113. A database server 114 typically provides a large amount of bulk memory storage capability. In a typical use, the work flow server 110 will store image files in the database server 114. Of course, the work flow server 110 will typically have its own memory devices, including a bulk memory storage device such as a hard disk drive or an optical memory device, and thus could also store image files in its own bulk memory devices.

The image scanner 140 can be accessed from the network 100, and if desired a hard copy image could be placed on the scanner 140, and via either local or remotely-controlled commands, a scan can be made of that hard copy, and the resulting image data can be transmitted over the network 100 to a receiving device, such as the work flow server 110, or perhaps the client PC 10 directly. Other types of image sourcing devices could also be connected to the network 100, and that general capability is depicted by the image scanner 140.

The multifunction device 150 can perform different functions. In one instance, MFD 150 it can act as a printer and receive image data from the network 100. In the other instance, MFD 150 can scan a hard copy and generate image data, which can then be sent to the network 100, much as the capability of the image scanner 140. The image data transmitted from or received by MFD 150 can be communicated via network 100 to or from the work flow server 110 or perhaps the client PC 10.

Software Module Description:

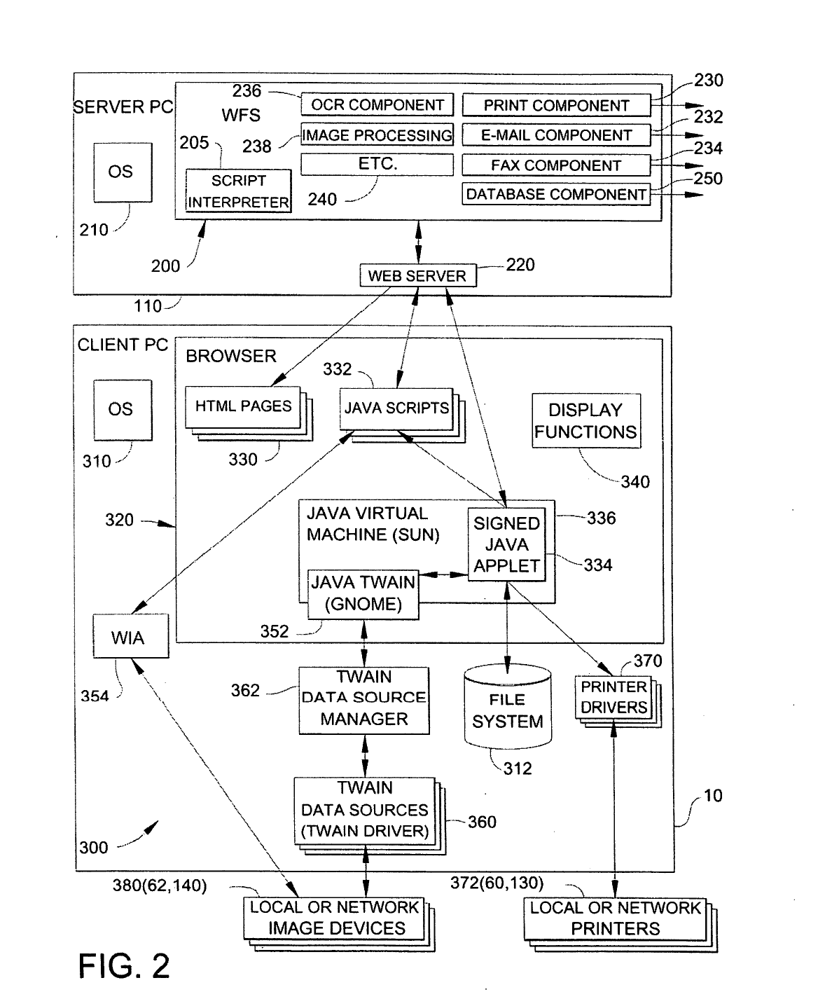

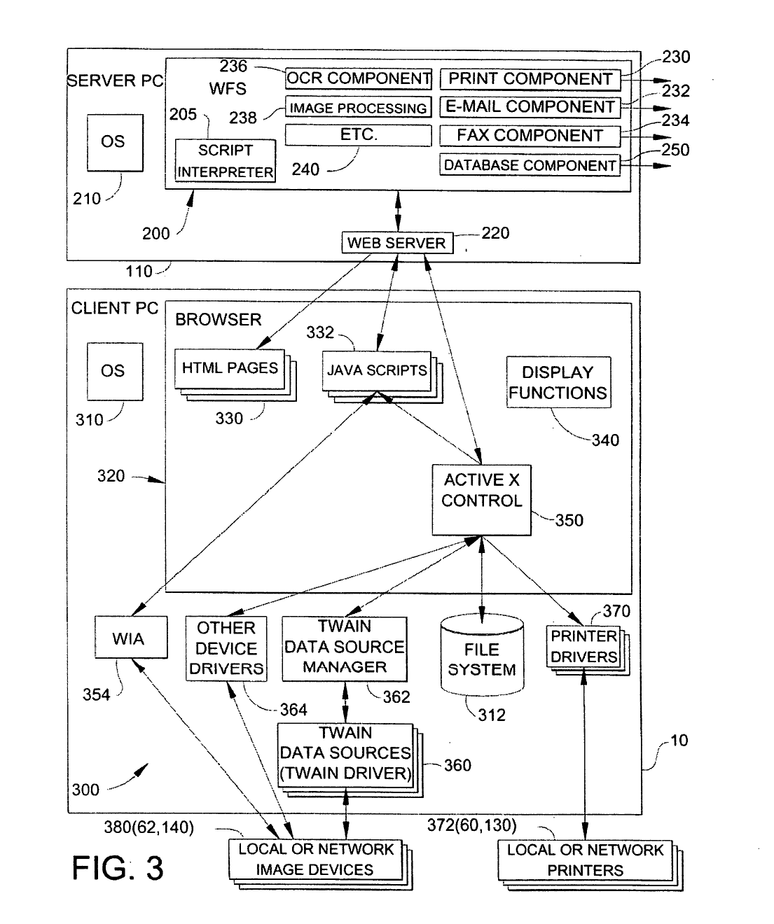

Referring now to FIGS. 2 and 3, many of the software modules that are used in the present invention are depicted, along with certain peripheral hardware devices that are in communication with the client PC. Most of the software components are found on both drawings, however, there are two primary “modes” described below. FIG. 2 depicts a mode that uses a Java applet with a native interface, such as a virtual machine. FIG. 3 depicts a mode that uses an ActiveX control.

In FIG. 2, the work flow server 110 functions are generally depicted as a set of software components by the reference numeral 200 and are resident on a server PC 110 (which is also referred to herein as the “work flow server”). One of the modules running on the work flow server 200 is operating system 210. In addition, a web server interface application module is generally designated by the reference numeral 220. This interface allows the work flow server 200 to communicate with a web browser program over the network 100. This interface 220 can contain multiple URL addresses, which will be discussed below in greater detail.

The web server interface 220 also has a capability of communicating with a script interpreter 205. When a user selection is transmitted from client PC 10 to the work flow server 200, a predetermined script will be interpreted by script interpreter 205, which may invoke one or more other application modules that are part of the standard work flow server 200. Some of these modules (or components) may include a print function 230, an e-mail function 232, and a fax function 234. These application modules or software “objects” have the capability of outputting some data, such as to a physical printing device, or through a communications channel that will communicate to another computer (for the e-mail function, for example), or communicate to a hardware fax machine, for example.

Other work flow server functions include an optical character recognition (OCR) function 236, and a set of database or file functions 250, which can communicate with the database server 114, or can store image files on a bulk storage device in the work flow server 110 itself, if desired. The web server interface 220 can also call scripts that can invoke various image processing functions, including new functions that are provided to support the work flow web application functions of the present invention, in which these image processing functions are generally designated by the reference numeral 238. One such image processing function could be to add a number, such as a Bates number, to each page of an image file that has been received by the work flow server 110 from the client PC 10. Other processing functions can be added to the work flow server 200, and these “other” functions are represented by the reference numeral 240. For example, one such “other” function may be an EDMS or an ECM.

The client PC 10 is depicted as containing a large set of software functions on FIG. 2 relating to the work flow web application of the present invention, generally designated by the reference numeral 300. Client PC 10 would include an operating system 310, typically a Windows™ operating system, or some other type of graphical user interface (GUI) software system such as Linux, Mac, Bea, UNIX or OS2. Another primary element of the software for the client PC 10 is a web browser, generally designated by the reference numeral 320. The browser may be a standard type browser, such as Internet Explorerm, Netscape™ or Mozilla.

Running within the browser 320 are a number of software objects that are part of the work flow web application 300 of the present invention. This includes a set of HTML pages 330, and JavaScript functions 332. In addition, Java code functions could be used in the work flow web application 300, such as Signed Java Applets, as depicted at 334 on FIG. 2. In one embodiment of the present invention, these pages and functions of the work flow web application 300 are not resident on the client PC 10 upon start-up, but are downloaded from the server PC 110 only after a URL call has been made by the browser 320, discussed in greater detail below.

In many situations, it is useful to have a Java virtual machine running within the browser 320, so that type of machine is depicted at the reference numeral 336. A standard Java virtual machine has been developed by Sun Microsystems. Use of JavaScripts or Java applets may provide extra capabilities, and with today's modern browsers, many of the script engines are part of the browser, such as a JavaScript interpreter, or a Java virtual machine (i.e., running within the browser). However, virtual machines developed by companies like Sun are typically installed separately, but nevertheless run within the browser architecture.

Other functions that may be useful in the present invention include “display” functions generally designated by the reference numeral 340, which allow HTML pages, or pages run under JavaScript or Java code to be displayed on the monitor 20 of the client PC 10.

As noted above, some of the software objects of the present invention include Java applets, HTML or scripts like JavaScript, as well as native components that will allow the browser objects to communicate with other resources that are outside the browser 320, but are still resident on the client PC overall software system. For example, a Java applet interacting with a native interface (i.e., “Java applet with native interface”) called “JavaTwain” could be utilized, as illustrated at 352, to receive information and commands from Java applets at 334. One such JavaTwain (or a newer version called “Morena, version 6.0,” but referred to herein as the “JavaTwain” software) is sold by Gnome, Ltd., located in Bratislava, Slovakia, and allows Java functions to talk to a TWAIN driver. In this mode of the present invention, the JavaTwain module 352 communicates with a TWAIN data source manager 362, to discover the available TWAIN data sources, and to allow the client's browser 320 to communicate with them. The TWAIN data sources are also referred to as “TWAIN drivers,” and are depicted at reference numeral 360.

Another type of interface that can be found on Windows-based machines is a Windows Imaging Architecture (WIA) driver, generally depicted at the reference numeral 354, which is Microsoft's image driver that essentially is a substitute for a TWAIN driver. The JavaScripts module 332 can communicate with the WIA driver module 354. Both the WIA driver module 354, and JavaTwain-type native interfaces, can communicate to a scanner 380, which-represents both a local scanner 62 and/or a network scanner 140.

It will be understood that the scanners 380 can represent virtually any type of image-sourcing device, including a digital camera. It will also be understood that many different types of image drivers will become available in the future, and will have new capabilities that have not been invented as of yet. These types of image drivers are generally represented by the WIA driver 354 on the software diagram of FIG. 2.

The client PC 10 may also include some further software functions within its overall capabilities of the work flow web application 300. This may include file system functions as a function block 312, which will receive and store data under the control of Java applets. Another typical software object may be one or more printer drivers 370, which can communicate with a printer 372. Printer 372 may be a local printer 60 or a network printer 130. Printer drivers 370 can receive image data from virtually any source within the client PC's work flow web application 300. Such printer drivers typically send print data to their associated printing devices, and such print data is often referred to as a “printjob.”

It will be understood that the printers 372 can represent virtually any type of image forming device, including ink jet printers and laser printers, and can also include multifunction devices (MFD's) and all-in-one printers (AIO's). It will also be understood that the scanners 380 represent any type of still image device, such as a digital camera or another hardware device that produces still images. This also includes multifunction printers (MFP's) and all-in-one printers (AIO's).

It will be typically found that the TWAIN driver 360 is provided by the image device manufacturer, such as the manufacturer of an optical scanner 380. If a local scanner 62 is used, then the image device will typically be locally attached to the client PC by a local communications port, such as a USB port or parallel port, etc. A network scanner 140 may also be attached to the network 100 and still be accessible by the user of the client PC 10.

Referring now to FIG. 3, most of the software components of FIG. 2 are also found on FIG. 3 and generally perform the same functions. The operating mode depicted in FIG. 3 does not use a Java virtual machine, but instead provides an ActiveX control 350 as the native interface between the browser 320 and the TWAIN data source manager 364. In this mode, a native interface such as an ActiveX control could be utilized to receive information and commands from the JavaScript functions 332. Other types of image drivers, represented by the software object 364 on FIG. 3, may also be used to communicate with the scanner 380 and may be driven by a native interface, such as an ActiveX control in the software object 350.

Software Logic Flow Description:

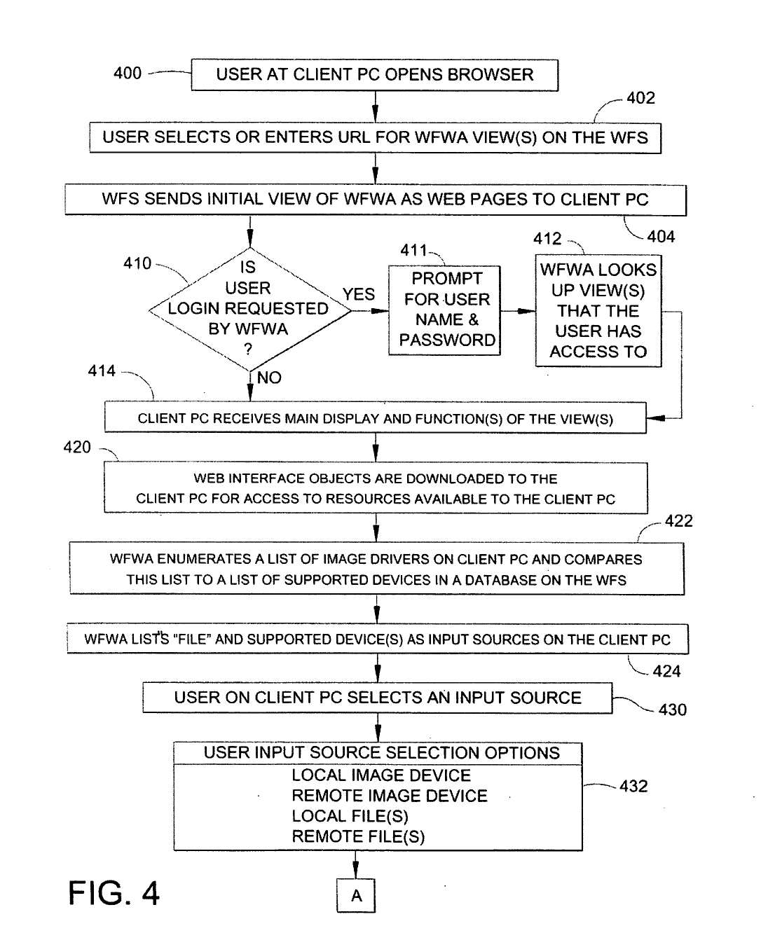

FIGS. 4-6 are a flow chart that depicts some of the logical functions and decision steps that are performed by the work flow web application of the present invention. It should be noted that most of the functions and decision steps that are depicted on FIGS. 4-6 are based on an actual product that has been released by Lexmark International, Inc., and that later releases will likely add extra capabilities that are not part of the present invention, but are nevertheless contemplated by the inventors as future improvements that build upon the present invention. Many of the important features of the present invention will likely be found in such future releases, including those future products having many enhancements that improve performance in various ways.

Referring now to FIG. 4, the first step 400 is where a user begins to run the work flow web application system. To do so, the user opens the web browser 320 on the client PC 10. After the browser has opened, the user goes to the URL of the work flow web application “view” on the work flow server 110, at a step 402. Different users can have different “views” that are provided by the same work flow server. For example, a User_A working in an accounting department would have access to certain “accounting views,” while a User_B working in a legal department would have access to certain “legal views” that are different in appropriate ways.

A web application/tool adds the capability to the work flow web application 300 of the present invention, in which different web pages, (or URLs/“views”) of the work flow web application system can be created and managed by a systems administrator. These web pages may be defined on the work flow server 110. The administrator can thus control the look of the web pages and the work flow server features that the work flow web application's web pages can access or execute. The work flow web application 300 sends Java/JavaScript calls with XML data to the work flow server to determine how portions of the work flow web application user interface should appear to the user. This is controlled by a systems administrator who previously has set up the work flow server with customized work flow web application views. The systems administrator can create views that allow functions to be accessed by pointing the browser to certain URLs. In one mode of the present invention, the work flow web application interface layout and functions are defined with data stored in a database on the work flow server. The administrator could go so far as to create a unique work flow web application view for each user in the company, or even more than one view for each user.

By accessing the appropriate URL, the work flow web application 300 may be started at the work flow server 110. As the work flow web application 300 starts at a step 404, HTML and JavaScript files are downloaded from the work flow server 110 to the client PC 10, and then interpreted by the browser 320 to give the user an initial view of the work flow web application. Part of the HTML functionality may start the work flow web application Java applet or other embedded objects like ActiveX controls on the client PC 10. For Java applets, the work flow web application Java applet may copy Gnome's Java code (that is stored on the work flow server 110) and Windows native *.DLL files to the client PC 10 from the work flow server 110. The work flow web application's applets may then use these files on the client PC 10 to give the work flow web application applets the ability to query and use an image device's driver. For other native interface controls, like ActiveX controls, the work flow web application 300 copies the necessary *.DLL files to the client PC IO.

At a decision step 410, the user may be requested to enter user login information (depending upon how the administrator set up the work flow web application system). Such user name and password logins can be used to look up a user's work flow web application views based on the user's work flow web application view references in the work flow server database 114. That way each user could get custom view and functionality from one URL that the user logs in to. If the user must enter login information, a step 412 looks up the views (at the work flow server 110) that the particular user will have access to.

An optional feature of the work flow web application system is to provide users with a single work flow web application URL that prompts the user for a user name and password, instead of there being many different URLs that users may (or must) type into their browser to get an work flow web application view. The work flow web application would work in conjunction with the work flow server 110 to look up the user's registered work flow web application views. Then the work flow web application would build the view that has been defined for this user on the work flow server 110. If the user has several different views, then the work flow web application main view can contain tabs. The user can select the different tabs to see each of the work flow web application views that he or she has to work with, depending upon the user's particular status. (In this context, the term “status” has a meaning that relates to which “type” of user is using the system, e.g., a user in a legal department vs. a user in an accounting department. Such status will typically determine exactly which work flow web application views the user will be allowed to see.)

Also, each user's usage of work flow web application system and the work flow server can be tracked and logged. The user can later see what operating characteristics or functions he or she has performed over time. Also, administrators could manage this information, since all of the information resides on the work flow server 110.

The logic flow is now directed to a step 414, where the client PC 10 receives the main display from the work flow server 110, and corresponding functions for the appropriate views are now made available to the user.

Native (client side) files are copied to the client PC 10, at a step 420. The work flow web application 300 on the client PC now makes calls (Java to the Gnome JavaTwain software, JavaScript to the work flow web application's ActiveX controls, JavaScript to the manufacturer's WIA driver in the client system, etc.) to get a list of all image drivers on the client PC (also known as “enumerating”). Each image driver name is compared to a “supported device” database on the work flow server using Java/JavaScript calls with XML at a step 422. This database is populated on the server by a separate application that is run on the work flow server 110.

At a step 424, the image drivers that are supported are listed in the “Input Source” combo box (a drop down list) of the work flow web application on the client PC. This combo box is also where a file can be listed as an input source. This feature gives the user the ability to feed files from the client PC 10 or on network drives that the client PC has access to, into the work flow server system 110 through the work flow web application 300. This function is similar an existing LDSS function, “Select 'N Send.”

Once the full work flow web application interface is running on the client PC 10, a single button in the work flow web application user interface can be selected to perform an image acquisition from a selected image device. When an image acquisition is to occur, all communications between the work flow web application and the manufacturer's image driver goes through a browser software interface module, such as Gnome's JavaTwain applet, or an ActiveX control, and the like.

At a step 430, the user selects an image device that will be used by the work flow web application to acquire image data from the “Input Source” list being displayed on monitor 20, by the user interface (UI) of the work flow web application. The “scan” button(s) in the work flow web application's UI are associated with a script/profile on the work flow server. In Lexmark products, a script/profile is a block of text data that can be interpreted dynamically by the work flow web application and by the work flow server. Selecting one of the “scan” buttons starts the process. The actions (scan, dynamic prompt, etc.) that are performed are controlled by the associated script/profile. Part of these scripts/profiles can represent scan settings. The systems administrator would add this data to the scripts/profiles as they are created on the work flow server 110. The administrator would use the image device's driver to determine what settings could be set. This feature lets the administrator set the default scan settings of the “scan” buttons, and so the user may never need to make a scan setting change. The work flow web application can use the scan settings in the script/profile to set scan settings during the scan job.

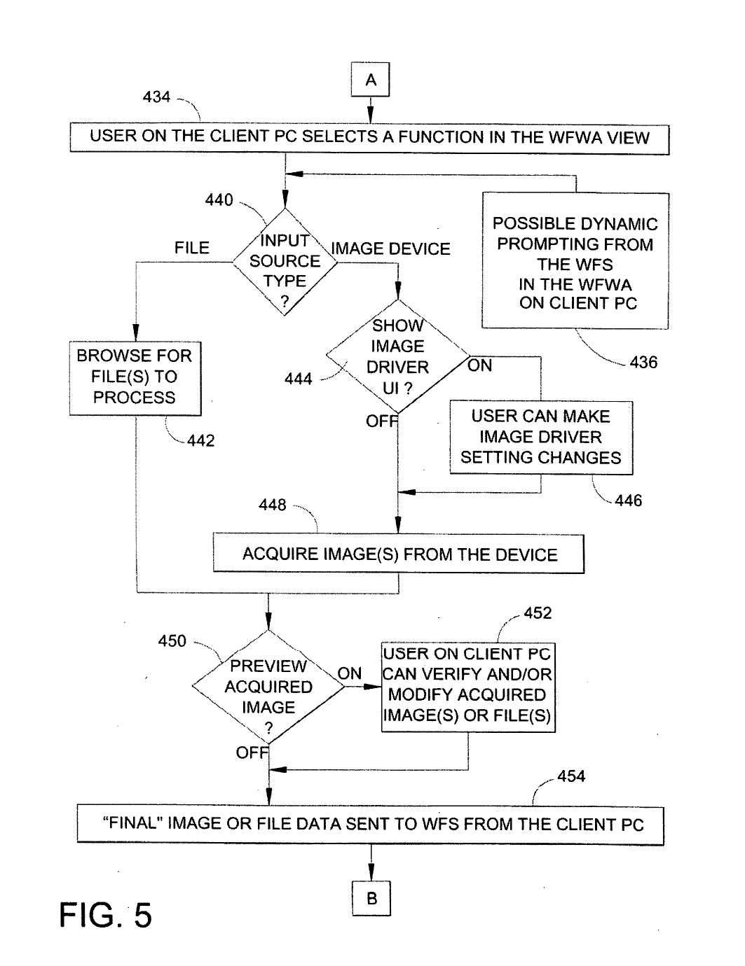

As discussed above, the user may select an input source from the “Input Source” list. In general, the user's selection options will include: (1) local image devices, (2) remote image devices, (3) local image files, and (4) remote image files. These are the main choices set forth at an information step 432 on FIG. 4. The logic flow now follows through a block “A” and over to FIG. 5, where it is directed to a step 434, where the user may select a function in one of the work flow web application views. The work flow web application system is capable of providing dynamic prompting via the work flow server 110 to aid the user in making this choice (as indicated at a function block 436).

A decision step 440 determines whether the input source type is a file or an image device. If a file is to be the input source, then a step 442 browses for the file on the client PC 10, or on the work flow server 110 (which will in turn inspect the database server 114), or for other network files that the user may have access to. If the input source is an image device, then a decision step 444 determines if a feature known as “Show Image Driver UI” is turned ON. If so, a step 446.allows the user to make changes to the image driver settings. This feature is also referred to as a “Show Scanner Interface” ON or OFF optional function.

If the work flow web application setup has “Show Scanner Interface” ON from an earlier “Scan Preferences” dialog, then the selected scanner driver's user interface will be displayed after the work flow web application “scan” button is selected but before the actual act of scanning. This interface can allow the user to change settings of the scan such as resolution and paper size. The scan settings can be pulled from the local image driver that is resident on the client PC 10. The image driver's user interface will be displayed on the user's monitor 20, and the user can make scanner setting selections at that time. If there are scan settings in the script/profile that are associated with the “scan” button, then the work flow web application may or may not use standard image driver interface calls to hide controls and/or settings within controls related to the settings in the script/profile. In that manner, the script/profile settings have precedence over settings in the scanner's driver if the scanner driver's UI is displayed. However, if there are settings in a script/profile (such as resolution) and the work flow web application allows the scanner's driver to display a resolution control and all of its settings, then the scanner driver's settings can be allowed to override the script/profile settings.

An image is now acquired from the selected image source device, at a step 448. Regardless of whether the image was acquired from a file or from a device, the logic flow is now directed to a decision step 450 to determine if a “Preview Scanned Images” (or other acquired images) control has been turned ON from the “Scan Preferences” dialog. If so, then the user will get a dialog that pops up showing what was scanned or acquired, and the user will have the opportunity to verify and/or modify the image data at a step 452. This image preview mainly gives the user a chance to make sure that the page(s) were scanned (or acquired) properly before the data is transmitted to the work flow server 110 for the additional processing by the associated script/profile. This preview capability may be used as an interface for the user to modify the acquired image data, such as by rotating an image, changing an image to a negative image, removing certain pages from a multi-page scan job, etc., before performing the other functions contained in the script/profile.

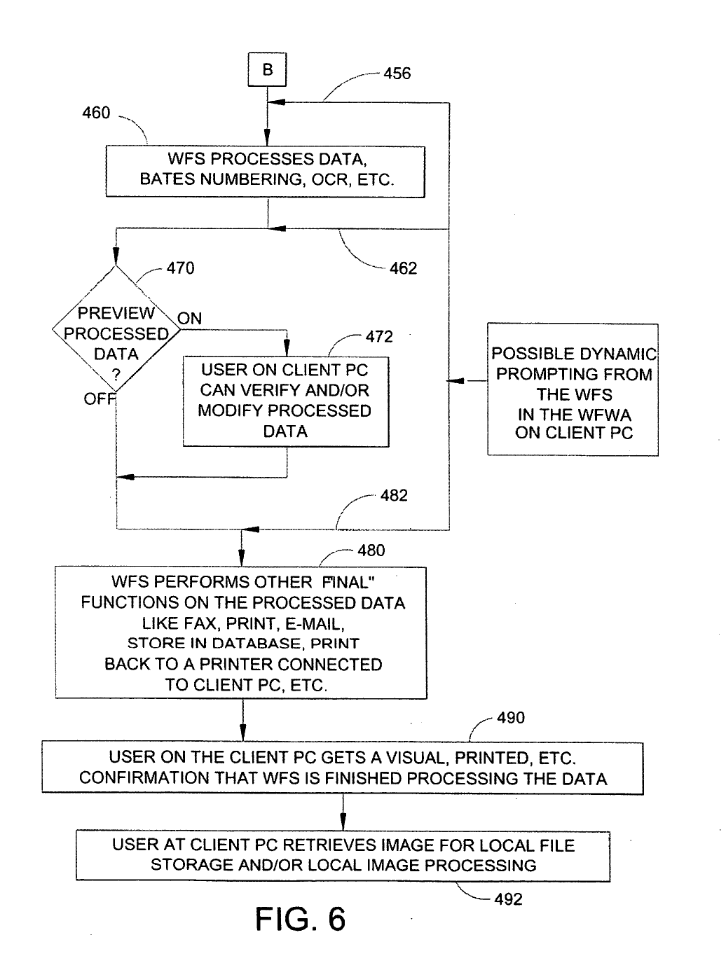

The “final” image data is now sent from the client PC 10 to the work flow server 110 at a step 454. The logic flow now follows through a block “B” and over to FIG. 6, where it is directed to a step 460. After the image acquisition has been performed and approved for processing, the work flow web application 300 tells the work flow server 110 (via Java and/or JavaScript calls) to perform the appropriate functions, including any image processing (such as Bates numbering, OCR, etc.), at step 460. Other possible functions to be performed by the work flow server include printing the image, e-Mailing the image data, sending the image to an EMDS or ECM system, storing the image in a database (such as in the database server 114), and the like, as discussed below. These functions were determined in the script/profile associated with the work flow web application button that was previously selected.

It should be noted here that part of the script/profile may call for user input, such as the user's name, user's password, the printer IP address that the “scan job” (i.e., the work flow web application job) should be printed on, an e-Mail address, etc., using dynamic prompting. Such optional functions are indicated at 456 and at 462 on FIG. 6. Such dynamic prompting has been previously used in Lexmark products, such as for “Select 'N Send” and “Print 'N Send” Windows applications on client PCs and on the work flow server. In the present invention, the work flow web application 300 communicates with the work flow server 110 to get the prompting information to build the dialog that is displayed on the client PC 10. The prompting is controlled by the logic in the script/profile, so prompting can occurs at any point after the “scan” button is selected in a work flow web application view. After a scan button is selected, the script may cause the work flow web application to prompt, then scan, and then prompt for more information; these steps can repeat. The prompt typically is a Windows dialog or a popup browser page. The communications between the work flow web application 300 and the work flow server 110 typically are Java and JavaScript calls with XML data.

Other types of prompts also can be used, such as single selection combo boxes (drop down lists), multiple selection list boxes, radio buttons, numeric spin controls, slider bars, and the like. The script/profile can control the selections in the prompt controls, such as items in combo or list boxes, or what letters are allowed in an edit input box, or the allowable range of numbers in a numerical spin control, etc.

When using the dynamic prompting, the user enters the data and selects the “Next” button. When the user selects the “Next” button, the work flow web application system can validate data entered into the prompt according to the script/profile. If the data is not acceptable, the work flow web application 300 can prompt for correct data. If the data is acceptable, then the work flow web application sends the data to the work flow server 110 via Java/JavaScript calls with XML data, and continues processing the script/profile. Depending on the client PC settings, the prompt could be translated. If the client PC 10 is set up in Italian, for example, then the prompt will be presented in Italian. All of the work flow web application 300 may be translated dynamically, depending on how the client PC is set. The work flow web application user presentations can be translated into any desired language, including double byte character set (DBCS) languages such as Japanese, Korean, and Chinese.

In one mode of the present invention, when the entire image job is submitted to the work flow server 110, the work flow web application 300 will wait for a completion message from the work flow server to let the user know if his or her job completed successfully. The work flow web application system does this by starting a separate thread via JavaScript that opens an IP port to the work flow server 110, and waits for a completion response on that port. When a response is received, a dialog is displayed on the client PC 10 to let the user know what happened to the job. The response can also be logged. Then the user can look at all of the responses he or she has received from the work flow server, without having to get a prompt each time.

After image processing has been performed at the work flow server 110 (at step 460), the user may preview the processed image data. A decision step 470 determines if a function “Preview Processed Data” is turned ON, and if so, the user may verify the image data, and/or may modify the processed image data at a step 472. For example, if the work flow server was supposed to perform Bates numbering, then the user at step 472 can visually determine whether or not the work flow server has actually placed a Bates number in the image page. In that manner, the user can double check the work flow functioning before the work flow server e-mails the job to hundreds of people, for example.

The work flow server will now perform other “final” functions at a step 480, such as faxing or e-mailing the image data, sending the image to an EMDS or ECM system, storing the image, or printing the image, etc. In addition, instead of the work flow server printing to a printer over its IP ports, work flow scripts/profiles may have the added capability of printing to printers connected to client PCs (using a “print-back” function). This can be done by adding logic to work flow scripts/profiles to route work flow processed data back to a printer that is connected to the client PC 10, such as the locally-attached printer 60 on FIG. 1. Because the work flow web application system is a web application, it will take the processed data from work flow server 110 and print the data via a native interface (such as an ActiveX control), or a Java applet. Dynamic prompting can be used here, as indicated at the arrow 482 on FIG. 6.

The user at the client PC 10 may receive a visual or printed confirmation that the work flow server has finished processing this data, at a step 490. The user may also retrieve the image from the work flow server for local file storage (e.g., on the client PC's bulk memory device 36) at a step 492. The user may also perform further image processing at the client PC 10.

Other Optional Features are Discussed Below:

Instead of using dynamic prompts to obtain user information to add to the image data, the work flow web application 300 could present the image or form data for the user to fill in directly.

The work flow web application 300 could also contain all, or a subset of the functionality (copy/fax/e-mail) of a work flow server, but instead perform these functions on the client PC 10. As such, the work flow web application system could become a self-contained “web” application on the client PC, in which the work flow web application system would essentially become a directory of HTML, JavaScript, and certain native components (like ActiveX controls) on the client PC 10, and would not need an work flow server for copying, faxing, e-mailing, and perhaps other functions.

Some MFP or AIO printer devices only come with a flatbed scanner, however, some users would like to perform multi-page scan jobs with the flatbed scanner. The work flow web application system can perform logic to scan one sheet at a time from a flatbed scanner, but place each of the scanned pages into a single multi-page scan job for the user. The work flow web application 300 would prompt the user to insert the page to be scanned into the flatbed, scan the page, and prompt to see if the user is finished, or if the user would like to scan another page. This type of multi-page scan job could also be done with a scanner's automatic document feeder (ADF), and appropriate prompts can be provided each time another stack of pages needs to be inserted into the ADF. If the user selects that he or she is finished (or “Done”), the work flow web application may display the preview page(s) so the user can inspect the multi-page scan job before the job is submitted to the work flow server for further processing.

It will be understood that the logical operations described in relation to the flow charts of FIGS. 4-6 can be implemented using sequential logic, such as by using microprocessor technology, or using a logic state machine, or perhaps by discrete logic; it also could be implemented using parallel processors. One preferred embodiment may use a microprocessor or microcontroller (e.g., microprocessor 30) to execute software instructions that are stored in memory cells within an ASIC. The entire microprocessor 30 (or a microcontroller) along with dynamic RAM and executable ROM may be contained within a single ASIC, in a preferred mode of the present invention. Of course, other types of circuitry could be used to implement these logical operations depicted in the drawings without departing from the principles of the present invention.

It will be further understood that the precise logical operations depicted in the flow charts of FIGS. 4-6, and discussed above, could be somewhat modified to perform similar, although not exact, functions without departing from the principles of the present invention. The exact nature of some of the decision steps and other commands in these flow charts are directed toward specific future models of printer systems (those involving Lexmark printers, for example) and certainly similar, but somewhat different, steps would be taken for use with other types of printing systems in many instances, with the overall inventive results being the same.

The foregoing description of a preferred embodiment of the invention has been presented for purposes of illustration and description. It is not intended to be exhaustive or to limit the invention to the precise form disclosed. Obvious modifications or variations are possible in light of the above teachings. The embodiment was chosen and described in order to best illustrate the principles of the invention and its practical application to thereby enable one of ordinary skill in the art to best utilize the invention in various embodiments and with various modifications as are suited to the particular use contemplated. It is intended that the scope of the invention be defined by the claims appended hereto.

The invention claimed is:

1. A networked system, comprising:
(a) a work flow server that is in communication with a computer network containing first computer executable code;
(b) a client computer that is in communication with said work flow server over said computer network containing second computer executable code; and
(c) an image sourcing device that is in communication with said client computer; wherein said second computer executable code includes: (i) a web browser that is in communication with said work flow server over the computer network; (ii) an image device driver that is in communication with said image sourcing device; and (iii) a software interface module that interfaces between said web browser and said image device driver.

2. The networked system of claim 1, wherein: (a) said image sourcing device comprises an apparatus that generates a still image data; and (b) said image device driver comprises a software driver that receives said still image data from said image sourcing device.

3. The networked system of claim 1, wherein: (a) said image sourcing device comprises one of: (i) a scanner, (ii) a digital camera, and (iii) a bar code reader, (b) said image device driver comprises one of: (i) a TWAIN driver and (ii) a WIA driver; and (c) said software interface module comprises one of: (i) an ActiveX control, (ii) a Java applet with native interface, and (iii) JavaScript.

4. The networked system of claim 1, wherein said image sourcing device generates a first image data and transmits said first image data to said client computer; and wherein said client computer transmits said first image data to said work flow server.

5. The networked system as recited in claim 4, wherein said first computer executable code includes at least one of: (i) an image processing component that receives said first image data and generates a second image data from said first image data; (ii) a print component that transmits a print job based upon one of said first image data and said second image data to a first printer; (iii) a fax component that transmits fax-formatted data based upon one of said first image data and said second image data to a facsimile machine; (iv) an e-mail component that transmits one of said first image data and said second image data to a remote computer over said computer network; (v) an optical character recognition component that converts one of said first image data and said second image data into a set of characters; (vi) a database component that stores one of said first image data and said second image data as a file onto a bulk memory device resident on said work flow server; (vii) a database component that stores one of said first image data and said second image data as a file onto a bulk memory device, and (viii) an electronic document management system component that can process or manage said first image data and said second image data.

6. The networked system of claim 5 wherein said work flow server transmits said second image data back to said client computer over said computer network and a second printer locally-connected to said client computer contains a printer driver which converts said second image data into a print job that is sent from. said client computer to said second printer.

7. A method for receiving image data and processing image data using a work flow server that is in communication with a client computer over a computer network and an image sourcing device in communication with said client computer, said method comprising:
(a) establishing a communications session between said work flow server and said client computer over said computer network, through a URL in a web browser resident on said client computer, wherein said URL identifies an address on said work flow server; and
(b) communicating first image data from an image device driver to said web browser resident on said client computer through a software interface module resident on said client computer.

8. The method as recited in claim 7, further comprising the step of: communicating said first image data from said web browser to said work flow server over said computer network.

9. The method as recited in claim 7, wherein: (a) said work flow server includes a first processing circuit, a first memory circuit, and a first computer executable code; and (b) said client computer includes a second processing circuit, a second memory circuit, and a second computer executable code.

10. The method as recited in claim 8, further comprising the step of performing at said work flow server image processing on said first image data to generate a second image data according to at least one selected image processing function.

11. The method as recited in claim 8, further comprising the step of performing at said work flow server at least one of:
(a) transmitting a print job to a printer based upon said first image data;
(b) transmitting fax-formatted data to a facsimile machine based upon said first image data;
(c) transmitting said first image data in an e-mail;
(d) storing said first image data in a database;
(e) converting said first image data into characters by use of an optical character recognition function; and
(f) managing said first image data via an electronic document management system.

12. The method as recited in claim 7, wherein the step of communicating from said software interface module to said web browser comprises one of:
(a) sending said first image data from said image sourcing device to a TWAIN data source, then under the control of a Java virtual machine to a Java applet with native interface via a TWAIN data source manager;
(b) sending said first image data from said image sourcing device to a TWAIN data source, then to an ActiveX control via a TWAIN data source manager; and
(c) sending said first image data from said image sourcing device to a WIA driver.

13. The method as recited in claim 7, wherein the step of establishing a communications session between said work flow server and said client computer, comprises the steps of:
(a) opening said web browser at said client computer;
(b) sending an initial view of a work flow web application to said client computer, where said initial view is displayed on a monitor at said client computer; and
(c) determining at said work flow server which views are accessible by a user identified by said work flow server, and sending a main view and computer executable code of appropriate functions of said work flow web application to said client computer, wherein said appropriate functions correspond to a status of the user.

14. The method as recited in claim 13, further comprising the steps of:
(a) displaying to said user a list of appropriate supported devices and files as input sources;
(b) receiving from said user a selected input source;
(c) providing to said user a set of processing functions;
(d) receiving from said user at least one selected processing function from said set of processing functions; and
(e) acquiring said first image data from the selected input source.

15. The method as recited in claim 14, further comprising the step of selecting at least one processing function to be performed on said first image data at said work flow server, wherein said at least one processing function comprises at least one of:
(a) transmitting a print job to a printer based upon said first image data;
(b) transmitting fax-formatted data to a facsimile machine based upon said first image data;
(c) transmitting said first image data in an e-mail to an e-mail server on said computer network;
(d) storing said first image data in a database;
(e) converting said first image data into characters by use of an optical character recognition function;
(f) managing said first image data by an electronic document management system on said computer network; and
(g) generating a second image data according to at least one selected image processing function.

16. The method as recited in claim 10, further comprising the steps of:
(a) allowing a user to preview said second image data;
(b) allowing said user to modify said second image data by performing an image manipulating function, thereby generating a third image data;
(c) sending said third image data to said work flow server; and
(d) performing a selected processing function on said third image data at said work flow server.

17. The method as recited in claim 14, further comprising the steps of:
(a) allowing said user to see an image driver user interface of said image device on a monitor at said client computer if said selected input source comprises an image device,; and
(b) allowing said user to make changes to settings of an image driver associated with said selected input source by use of an image driver user interface.

18. The method as recited in claim 14, further comprising the step of allowing the user to browse for a file that is stored at one of: (i) a memory device at said client computer; (ii) a memory device at said work flow server; and (iii) a memory device at a database server that is connected to said computer network, provided the selected input source comprises a file.

19. The method as recited in claim 14, further comprising the steps of:
(a) allowing said user to preview said first image data;
(b) allowing said user to modify said first image data by performing an image manipulating function, thereby generating a second image data; and
(c) sending said second image data to said work flow server; and
(d) performing at said work flow server at least one selected processing function on said second image data.

20. The method as recited in claim 19, wherein said at least one processing function comprises at least one of:
(a) transmitting a print job to a printer based upon said second image data;
(b) transmitting fax-formatted data to a facsimile machine based upon said second image data;
(c) transmitting said second image data in an e-mail to an e-mail server on said computer network;
(d) storing said second image data in a database;
(e) converting said second image data into characters by use of an optical character recognition function;
(f) managing said second image data by an electronic document management system on said computer network; and
(g) generating a third image data according to at least one selected image processing function.

21. The method as recited in claim 20, further comprising the steps of:
(a) sending said third image data back to said client computer; and
(b) printing said third image data under control of said client computer.

22. The method as recited in claim 20, further comprising the steps of:
(a) allowing said user to preview said third image data;
(b) allowing said user to modify said third image data by performing an image manipulating function, thereby generating a fourth image data; and
(c) sending said fourth image data to said work flow server; and
(d) performing at said work flow server a selected processing function on said fourth image data.

23. A method for receiving image data from an image sourcing device that is in communication with a client computer, said method comprising:
(a) generating a first image data at said image sourcing device and, under control of a work flow web application computer program;
(b) communicating said first image data to an image device driver resident on said client computer;
(c) communicating said first image data from said image device driver to a software interface module resident on said client computer under control of said work flow web application computer program; and
(d) communicating said first image data from said software interface module to a web browser resident on said client computer under control of said work flow web application computer program.

24. The method as recited in claim 23, further comprising the steps of:
(a) allowing a user at said client computer to enter a URL that identifies an address on a work flow server in communication with said client computer over a computer network; and
(b) after identifying a valid user at said client computer, sending from said work flow server at least one view that said valid user has access to at said client computer, wherein said at least one view comprises a first component of said work flow web application computer program.

25. The method as recited in claim 24, further comprising the steps of:
(a) under control of said work flow web application computer program, obtaining a list of device drivers available to said client computer;
(b) under control of said work flow web application computer program, comparing a list of supported devices at said work flow server to the list of available device drivers at said client computer; and
(c) under control of said work flow web application computer program, presenting a list of available supported devices using said available device drivers to said user, and allowing said user to select one of said available supported devices as an input source, wherein the selected one of said available supported devices comprises the image sourcing device.

26. The method as recited in claim 25, further comprising the steps of:
(a) under control of said work flow web application computer program, communicating said first image data from said web browser to said work flow server over said computer network; and
(b) at said work flow server, performing at least one selected processing function on said first image data, thereby generating a second image data.

27. The method as recited in claim 26, further comprising the steps of:
(a) allowing said user to preview said second image data;
(b) allowing said user to modify said second image data by performing an image manipulating function, thereby generating a third image data;
(c) sending said third image data to said work flow server; and
(d) performing at said work flow server a selected processing function on said third image data, thereby generating a fourth image data.

28. The method as recited in claim 25, further comprising the steps of:
(a) under control of said work flow web application computer program, allowing said user to preview said first image data;
(b) under control of said work flow web application computer program, allowing said user to modify said first image data by performing an image manipulating function, thereby generating a second image data;
(c) under control of said work flow web application computer program, sending said second image data to said work flow server; and
(d) at said work flow server, performing at least one selected processing function on said second image data, thereby generating a third image data.

29. The method as recited in claim 28, further comprising the steps of:
(a) allowing said user to preview said third image data;
(b) allowing said user to modify said third image data by performing an image manipulating function, thereby generating a fourth image data;
(c) sending said third image data to said work flow server; and
(d) performing at said work flow server a selected processing function on said fourth image data, thereby generating a fifth image data.
